(19) United States
(12) Patent Application Publication
(10) Pub. No.: US 2012/0166332 A1
(43) Pub. Date: Jun. 28, 2012

(54) BILL SPLITTING SYSTEM

(75) Inventor: Nadav Naaman, Palo Alto, CA (US)

(73) Assignee: EBAY INC., San Jose, CA (US)

(21) Appl. No.: 12/976,404

(22) Filed: Dec. 22, 2010

(51) Int. Cl. G06Q 40/00; G06Q 30/00

(52) U.S. Cl. 705/40

(57) ABSTRACT

An embodiment of a method for splitting a bill includes displaying a primary bill that includes a plurality of items on a first payer device. A plurality of inputs are received from the first payer device that assign the plurality of items to a first payer and at least one second payer to generate a first secondary bill and at least one second secondary bill. Each at least one second secondary bill is then sent to a respective second payer device, and payments are sent for the first secondary bill from the first payer device and each at least one secondary bill from the respective second payer device. An image of a physical bill may be taken by the first payer device and optical character recognition may be performed on the image to produce the primary bill that is displayed on the display of a first payer device.

### BACKGROUND

1. Field of the Invention

The present invention generally relates to mobile payments and more particularly to a bill splitting system for use in making mobile payments.

2. Related Art

More and more consumers are purchasing items and services over electronic networks such as, for example, the Internet. Consumers routinely purchase products and services from merchants and individuals alike. The transactions may take place directly between an on-line merchant or retailer and the consumer, and payment is typically made by entering credit card or other financial information. Transactions may also take place with the aid of an on-line or mobile payment provider such as, for example, PayPal, Inc. of San Jose, Calif. Such payment providers can make transactions easier and safer for the parties involved. Purchasing with the assistance of an on-line or mobile payment provider from the convenience of virtually anywhere using a mobile device is one main reason why on-line/mobile purchases are growing very quickly.

Typically, mobile payments are conducted between one payer and one payee and involve the payer receiving a bill or invoice from the payee and then providing full payment for the bill or invoice over an electronic network. However, in some situations, a bill or invoice may need to be ‘split’ or divided up into a plurality of bills. For example, a plurality of customers (payers) may order items together at a restaurant (payee), and those orders may be recorded for the plurality of customers as a group and presented in a single bill to the plurality of customers. The payment of such a bill with the assistance of a mobile payment provider raises a number of issues.

Conventionally, mobile payment for a bill that includes items to be paid for by a plurality of customers is accomplished by one of the customers entering the number of customers and a total amount due on the bill into a payer device. The payer device divides the total amount due by the number of customers to generate an equal amount due for each customer, and then sends a payment request to each customer. The customer using the payer device pays the total amount due on the bill with the assistance of the mobile payment provider, and then must wait to get reimbursed by each of the customers according to the payment requests sent using the payer device. Furthermore, each customer ends up paying an equal portion of the total amount due on the bill even through different customers have most likely purchased different items having different prices. Thus, the ‘even split’ of the total amount due on the bill that is determined by the payer device may cause some customers to pay for a larger portion of the bill than they should and some customer to pay for a smaller portion of the bill than they should.

Thus, there is a need for an improved bill splitting system for use in making mobile payments.

### SUMMARY

According to one embodiment, a method for splitting a bill includes displaying a primary bill on a display of at least one payer device, wherein the primary bill includes a plurality of items, receiving a plurality of inputs from an input device on the at least one payer device, wherein the plurality of inputs assign the plurality of items to a first payer and at least one second payer to generate a first secondary bill and at least one second secondary bill, and sending a payment for the first secondary bill from the at least one payer device over a network.

In an embodiment, the primary bill displayed on the first payer device is produced by performing optical character recognition on an image of a physical bill. In another embodiment the primary bill is an electronic bill sent over a network to at least one payer device.

As a result, a bill having a plurality of payers may be quickly and easily split between the payers based on the items purchased by each payer to produce a plurality of secondary bills, and each of those secondary bills may be paid with the assistance of a mobile payment provider.

These and other features and advantages of the present disclosure will be more readily apparent from the detailed description of the embodiments set forth below taken in conjunction with the accompanying figures.

### BRIEF DESCRIPTION OF THE FIGURES

FIG. 1a is a flow chart illustrating an embodiment of a method for splitting a bill;

FIG. 1b is a schematic view illustrating an embodiment of a bill splitting system;

FIG. 1c is a front view illustrating an embodiment of a physical bill;

FIG. 1d; is a schematic view illustrating an embodiment of a payer device being used to select payers and/or payees;

FIG. 1e is a schematic view illustrating an embodiment of a payer device being used to select payers;

FIG. 1f is a schematic view illustrating an embodiment of a payer device being used to display a primary bill and a plurality of payers;

FIG. 1g is a schematic view illustrating an embodiment of a payer device being used to assign an item in a primary bill to a payer;

FIG. 1h is a schematic view illustrating an embodiment of a payer device being used to display a plurality of secondary bills;

FIG. 1i is a schematic view illustrating an embodiment of a payer device being used to display and pay a secondary bill;

FIG. 2a is a schematic view illustrating an embodiment of a payer device being used to display a primary bill;

FIG. 2b is a schematic view illustrating an embodiment of a payer device being used to assign an item in a primary bill to a payer;

FIG. 2c is a schematic view illustrating an embodiment of a payer device being used to display and pay a secondary bill;

FIG. 3 is a schematic view illustrating an embodiment of a networked system used in a bill splitting system;

FIG. 4 is a perspective view illustrating an embodiment of a payer device;

FIG. 5 is a schematic view illustrating an embodiment of a payer device; and

FIG. 6 is a schematic view illustrating an embodiment of a payer device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for splitting a bill and paying for at least a portion of that bill with the assistance of a mobile payment provider. An assignable digital primary bill for a plurality of payers is provided on at least one payment device, and each of the items on that primary bill are assigned to one of a plurality of payers to produce a plurality of secondary bills that each correspond to a respective payer. Those secondary bills may then be sent to payment devices associated with their respective payer to be paid with the assistance of a mobile payment provider. The present disclosure also discloses a system and method for splitting a bill by a payee by assigning each of the items on an assignable digital primary bill to one of a plurality of payers to produce a plurality of secondary bills that each correspond to a respective payer, and the payee then sending each of the secondary bills to payment device associated with their respective payer to be paid with the assistance of a mobile payment provider.

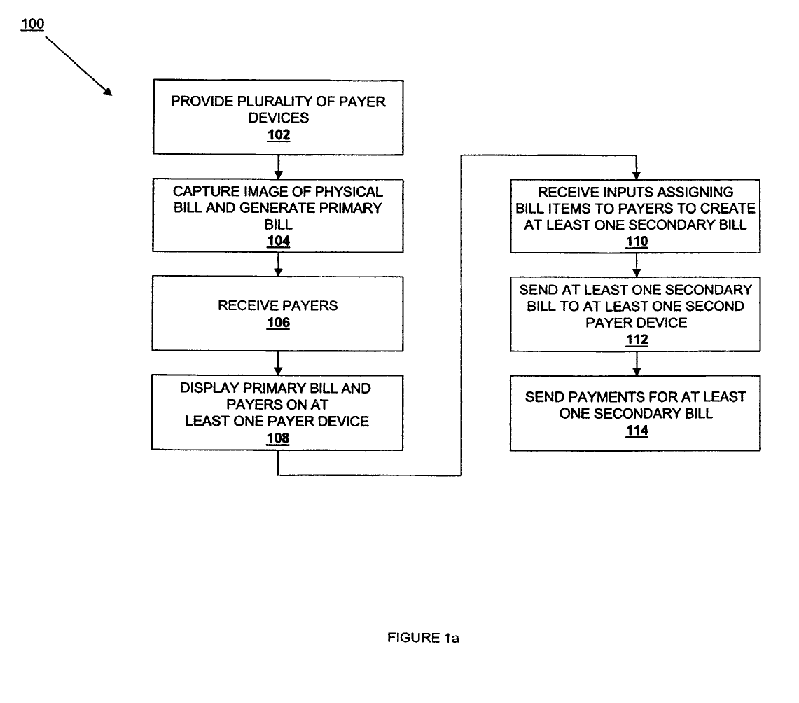

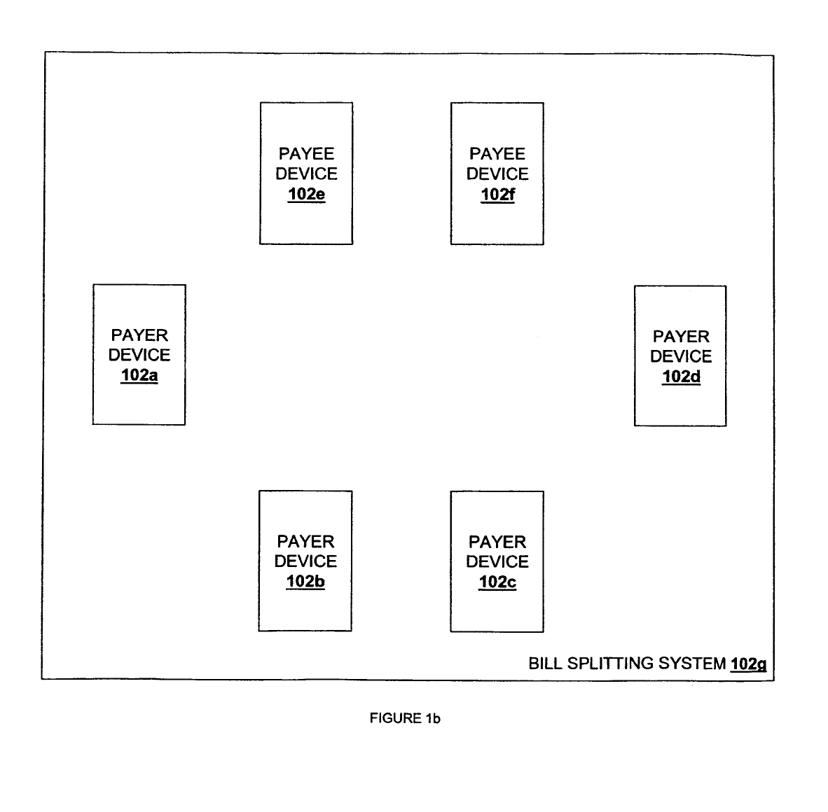

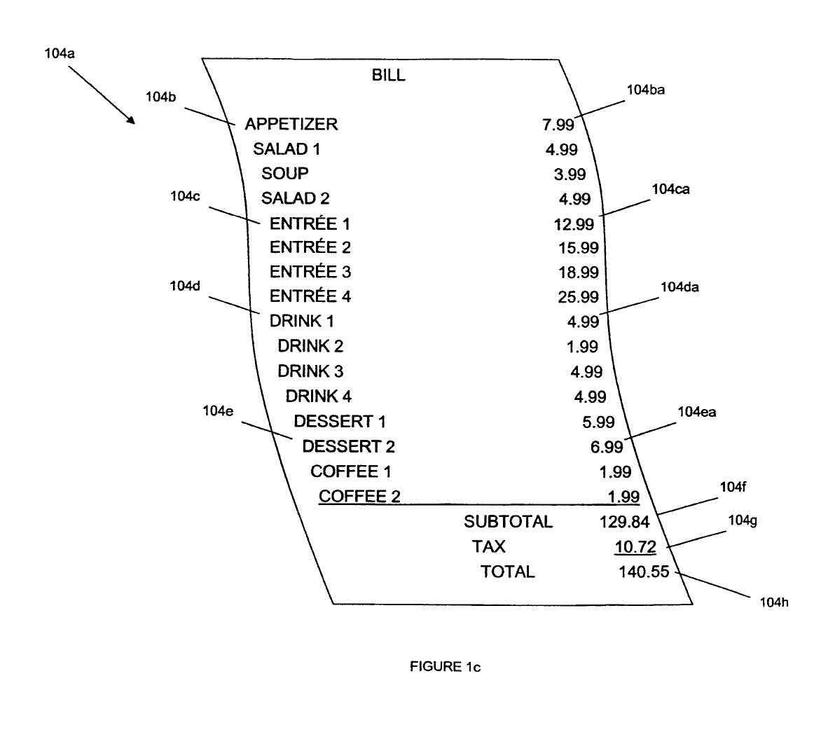

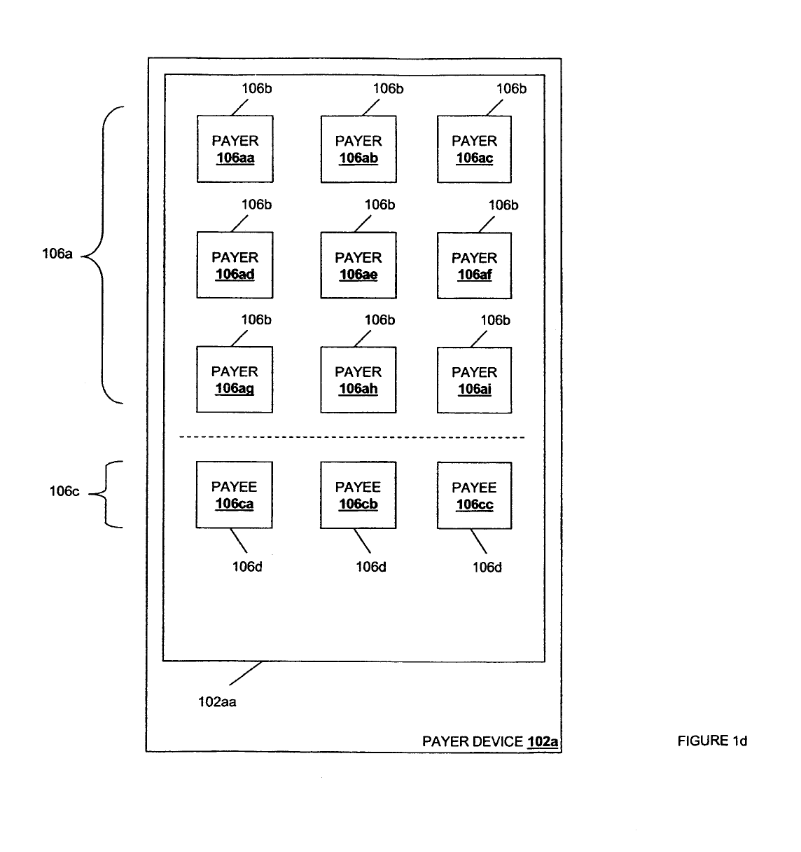

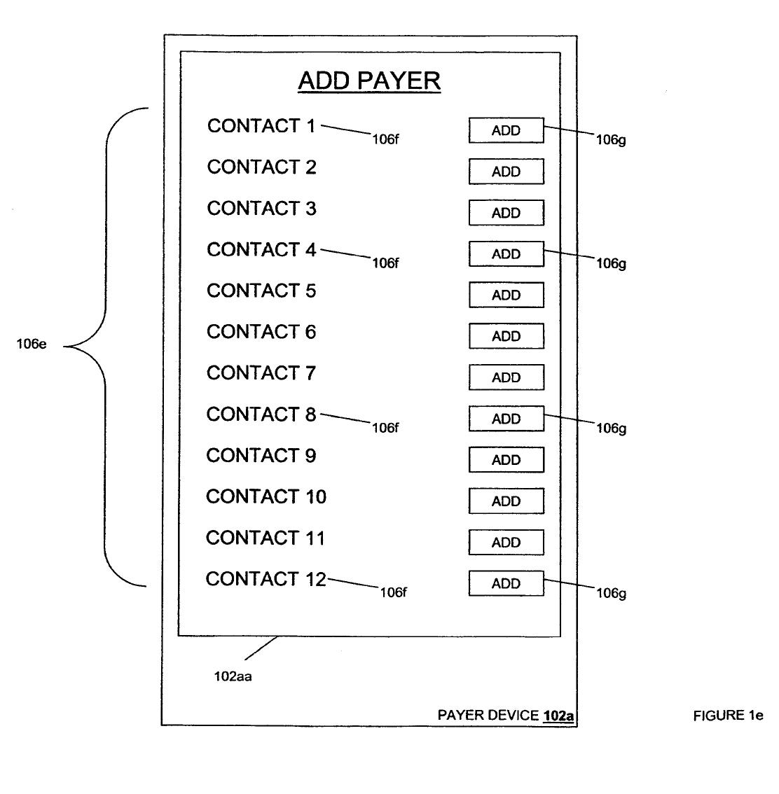

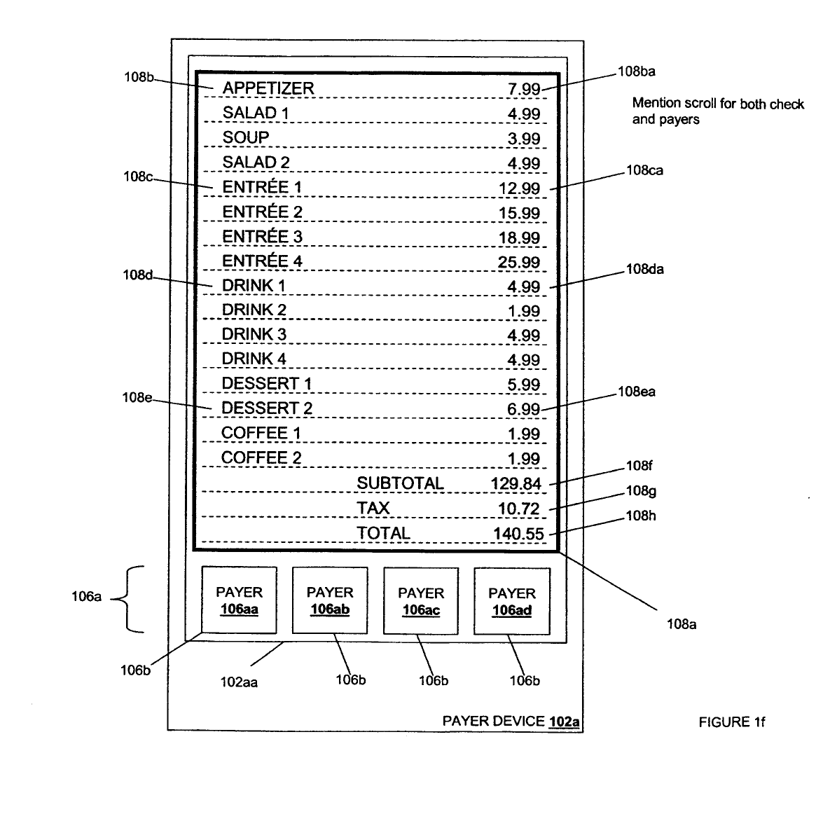

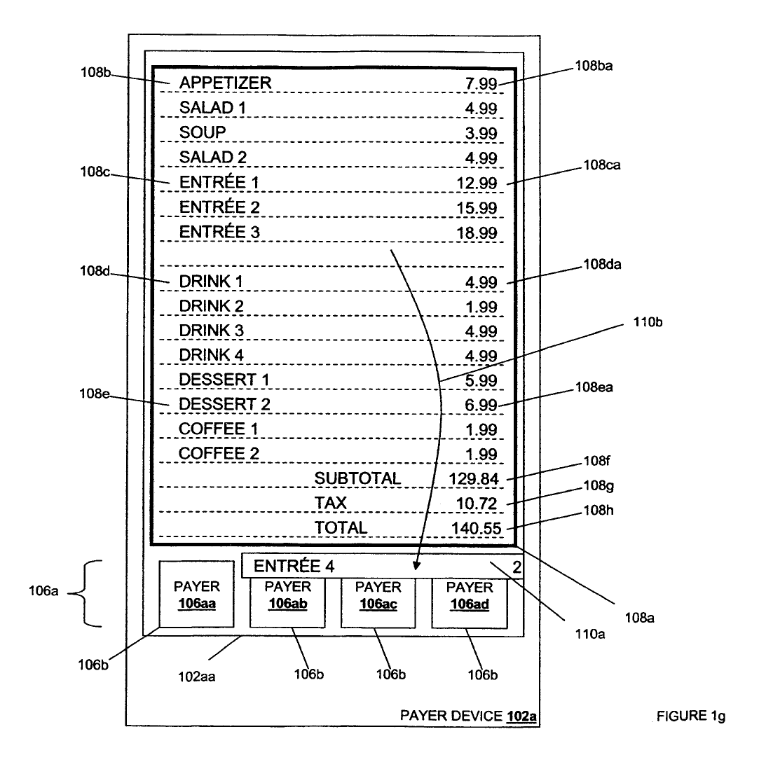

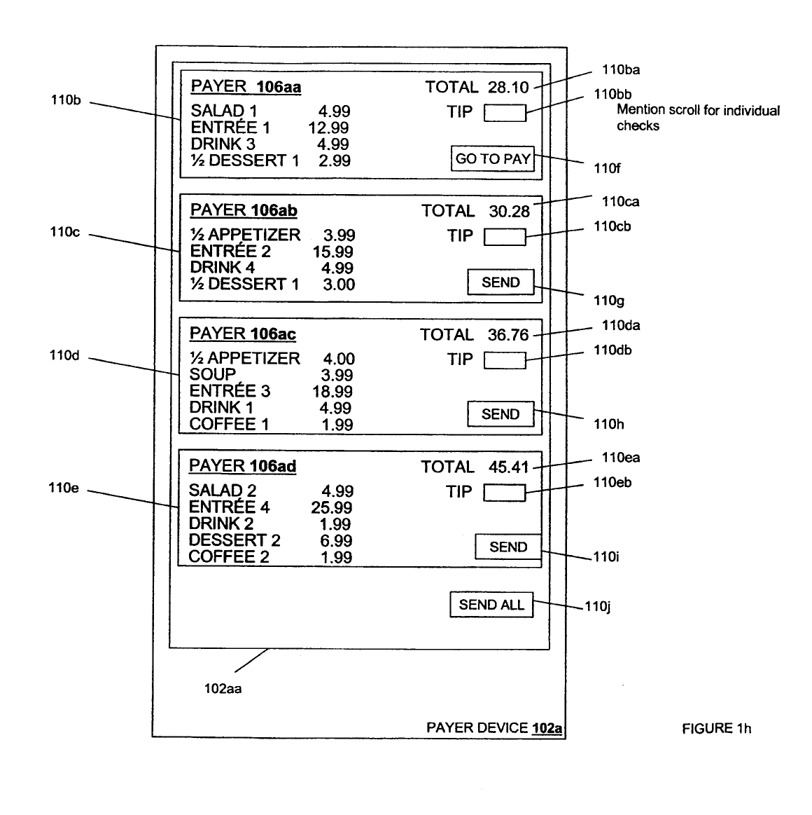

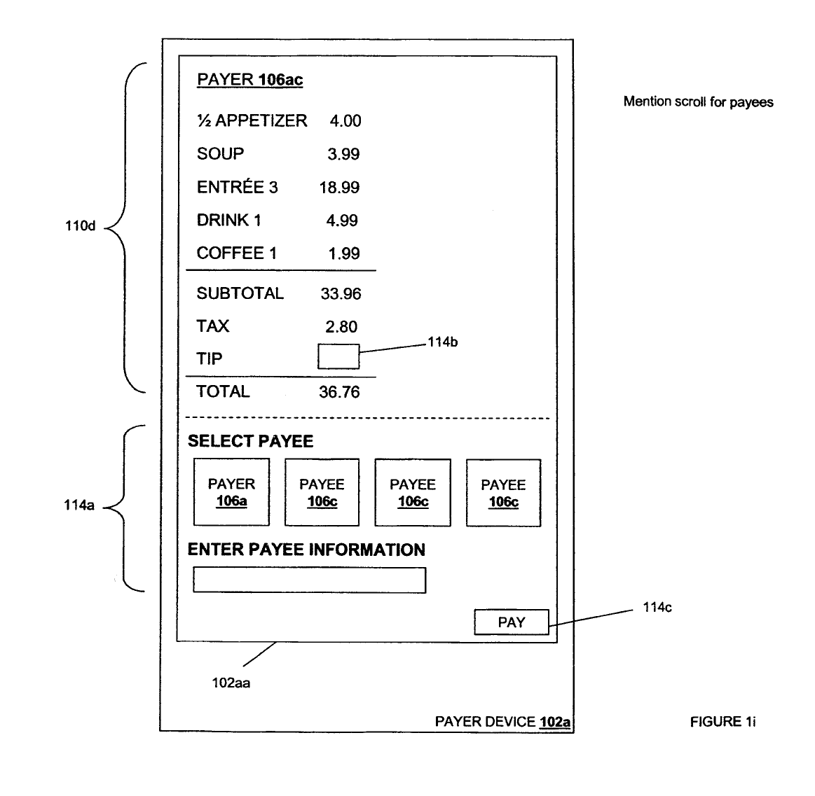

Referring now to FIGS. 1a and 1b, a method 100 for splitting a bill is illustrated. The method 100 begins at block 102 where a plurality of payer devices are provided. In an embodiment, a plurality of payers devices 102a, 102b, 102c, and 102d are provided. The payer devices 102a, 102b, 102c, and 102d may be coupled to each other and one or more payee devices 102e and 102f through a network to provide a bill splitting system 102g. In the method 100 discussed below, the bill splitting system 102g is described as being used to split a bill between a plurality of payees at a restaurant. However, one of skill in the art will recognize that the present disclosure is not so limited, and a variety of other situations that involve the splitting of a bill or invoice between a plurality of payees fall within its scope. In the current embodiment, each of a plurality of payers may have a payer device (e.g., one of the payer devices 102a, 102b, 102c, and 102d,) and may have ordered one or more items at a restaurant that has one or more payee devices (e.g., the payee devices 102e and 102f).

Referring now to FIGS. 1a and 1c, the method 100 then proceeds to block 104 where an image of a physical bill is captured. The plurality of payees at the restaurant may be presented with a physical bill 104a that includes a plurality of items, such as the items 104b, 104c, 104d, and 104e, that were ordered by the plurality of payees. Each item is associated on the physical bill 104a with a cost, such as the costs 104ba, 104ca, 104da, and 104ea. In additional, a subtotal 104f, which may be the sum of the costs of the items, is included on the physical bill 104a, along with a tax 104g associated with the subtotal 104f (e.g., 8.25% of the total in the illustrated embodiment) and a total 104h that may be the sum of the subtotal 104f and the tax 104g. While a particular physical bill has been described and illustrated, one of skill in the art will recognize that a variety of physical bills and/or invoices may replace the physical bill 104a without departing from the scope of the present disclosure. One or more of the payer devices 102a, 102b, 102c, and 102d may then capture an image of the physical bill 104a using, for example, a camera on the payer device to take an image of the physical bill as is known in the art. The payer device(s) that captured the image of the physical bill 104a may then use optical character recognition techniques to generate a primary bill that is an assignable digital representation of the physical bill 104a, discussed in further detail below. In an embodiment, a first payer device (e.g., the payer device 102a) may capture the image of the physical bill 104a and generate the primary bill. In another embodiment, a plurality of payer devices (e.g., the payer devices 102a and 102b, 102c, and/or 102d) may capture the image of the physical bill 104a and generate the primary bill.

Referring now to FIGS. 1a, and 1d, the method 100 then proceeds to block 106 where a plurality of payers are received. The payer device(s) that generated the primary bill in block 104 of the method 100 may determine that one or more payers 106a (e.g., payers 106aa, 106ab, 106ac, 106ad, 106ae, 106af, 106ag, 106ah, and 106ai) are present in the bill splitting system 102g and display each of those payers 106a as payer icons 106b on the payer device(s) (e.g., on a display 102aa of a payer device 102a). In an embodiment, the determination that one or more of the payers 106a are present may be accomplished over a Bump™-type network by ‘bumping’ or physically engaging the payer device(s) that generated the primary bill and the payer devices of the one or more payers 106a to exchange information, as described in co-pending U.S. application Ser. No. 10/570,454, attorney docket no. 70481.170, filed on Sep. 30, 2009, and co-pending U.S. application Ser. No. 12/570,544, attorney docket no. 70481.171, filed on Sep. 30, 2009, the disclosures of which are incorporated herein by reference. Also, a variety of other Near Field Communication (NFC) techniques may be used to determine the presence of payers 106a and/or payer devices to display the payer icons 106b illustrated in FIG. 1d. Furthermore, a variety of other communication techniques known in the art may be used to determine the presence of the payers 106a and/or payer devices in the bill splitting system 102g. Information exchanged between the payer devices may include payer information such as payer contact information and/or any other information needed to display the payer icons 106b and send a secondary bill to a particular payer 106a and/or payer device (discussed in further detail below). In an embodiment, the payer device(s) that generated the primary bill in block 104 of the method 100 may use similar techniques to determine that one or more payees 106c (e.g., payees 106ca, 106cb, and 106cc) are present in the bill splitting system 102g and display those payees 106c as payee icons 106d on the payer device(s).

Referring now to FIGS. 1a, 1d, and 1e, payers may also be received at block 106 of the method 100 by accessing a contact list 106e on the payment device(s) that generated the primary bill in block 104 of the method 100 and selecting one or more contacts 106f stored on the payer device(s) to be added as payers (e.g., by selecting an “ADD” button 106g that is displayed adjacent the contact 106f on the display 102aa of the payer device 102a.) Information retrieved by the payer device(s) may include payer information such as payer contact information and/or any other information needed to display the payer icons 106b and send a secondary bill to a particular payer 106a and/or payer device (discussed in further detail below). The payer device(s) (e.g., the payer device 102a in FIG. 1d) may then be used to select the payers 106a that ordered one or more of the items that are on the physical bill 104a by, for example, selecting the payer icon 106b associated with that payer 106a. In an embodiment, by identifying the payers as discussed above, the payment system may use the connection used to identify those payers to complete any authentications and/or verifications needing to approve payments from the different payers. Furthermore, a payee 106c for whom payment on the physical bill is to be provided may be designated by selecting the payee icon 106d associated with that payee 106c.

Referring now to FIGS. 1a and 1f, the method 100 then proceeds to block 108 where the primary bill and payers are displayed on at least one payer device. In an embodiment, the payer device(s) that generated the primary bill in block 104 of the method 100 may display a primary bill 108a on that payer device (e.g., the display 102aa of the payer device 102a in FIG. 10 along with the payer icons 106b associated with the payers 106a that were selected in block 106 of the method 100 (e.g., the payers 106aa, 106ab, 106ac, and 106ad). In an embodiment, a payer icon 106b for a payer associated with the payer device that generated the primary bill in block 104 of the method 100 may be displayed (e.g., the payer icon 106b for the payer 106aa). In an embodiment, the optical character recognition techniques performed on the physical bill 104a provide the primary bill 108a that is a digital representation of the physical bill 104a and includes a plurality of assignable items (e.g., the assignable items 108b, 108c, 108d, and 108e) with associated assignable costs (e.g., the assignable costs 108ba, 108ca, 108da, and 108ea) that correspond to the items and costs on the physical bill 104a. The primary bill 108a also includes a subtotal 108f, a tax 108g, and a total 108h that correspond to the subtotal 104f, the tax 104g, and the total 104h on the physical bill 104a. In an embodiment, elements of the primary bill 108a (e.g., the items, costs, subtotal, tax, and/or total) may be edited using the payer device(s) to, for example, correct any errors that may result in the use of optical character recognition techniques on the physical bill 104a to provide the primary bill 108a. In an embodiment, when a plurality of payer devices generate the primary bill 108a and select the payers 106a, those payer devices may sync with each other to crosscheck and/or ensure the information on the primary bill 108a (e.g., the assignable items, assignable costs, subtotal, the tax, and/or the total) and/or the payers 106a are correct on each of the payer devices. In an embodiment, a single payer device (e.g., the payer device 102a) may generate and send the primary bill 108a and the selected payer icons 106b to the other payer devices (e.g., the payer devices 102b, 102c, and/or 102d) that are associated with the payers (e.g., the payers 106ab, 106ac, and 106ad).

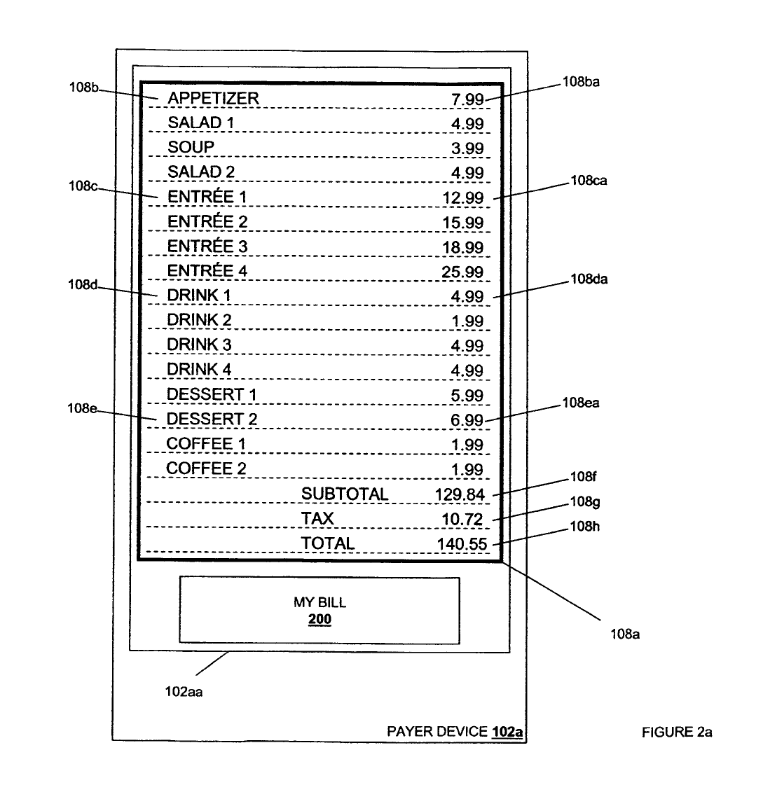

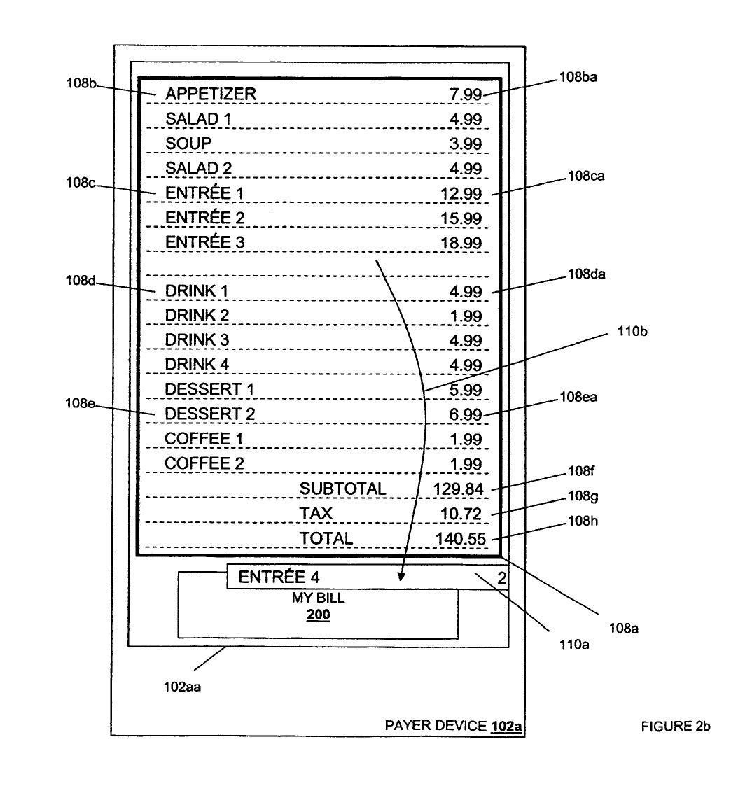

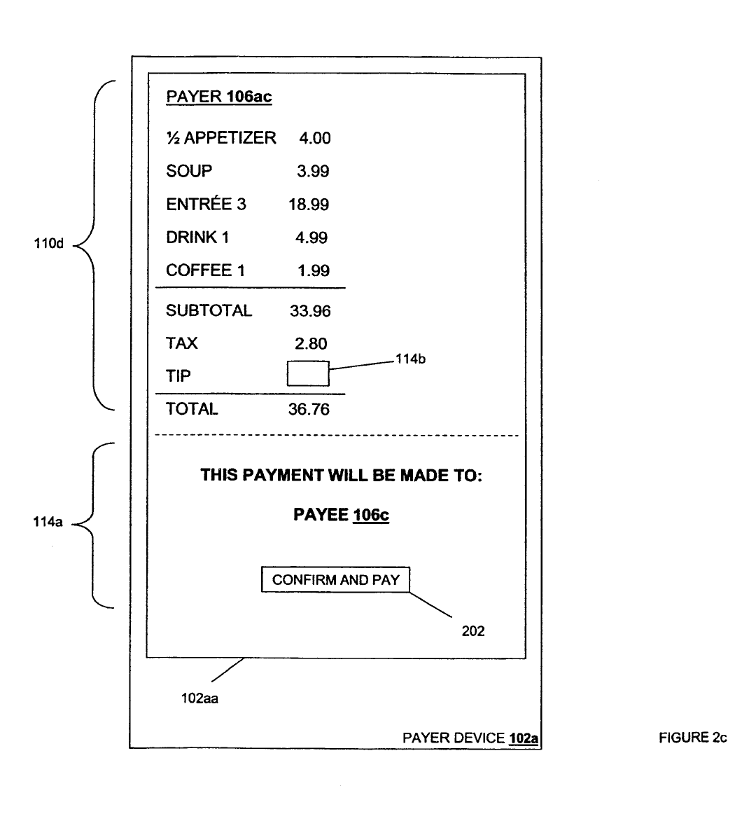

In an alternative embodiment, illustrated in FIG. 2a, block 104 of the method 100 may be skipped, and the primary bill 108a may be sent to the payer device(s) from a payee requesting payment. For example, a plurality of payers may order items, and those items may be included in an electronic primary bill 108a by the payee. The payee may then use a payee device (e.g., the payee device 102e or 102f) to select payers, for example, substantially as described above with reference to FIG. 1d, and send the primary bill to one or more of the payer devices associated with those payers. As can be seen in FIG. 2a, the payer device 102a may display the primary bill 108a on the display 102aa, and may also include a my-bill icon 200. Each of the payer devices belonging to the payers responsible for the primary bill 108a may receive the primary bill 108a such that it is displayed along with the my-bill icon 200 on their payer device in substantially the same manner as is illustrated for payer device 102a in FIG. 2a.

Referring now to FIGS. 1a, 1f, and 1g, the method 100 then proceeds to block 110 where a plurality of inputs are received that assign bill items to payers to create at least one secondary bill. In an embodiment, the display 102aa may be a touch input device that allows a payer to select one of the assignable item 110a (e.g., ENTRÉE 4 in the illustrated embodiment) by touching that assignable item 110a, dragging that item across the display (as indicted by arrow 110b,) and assigning that assignable item 110a to one of the payers 106a by ‘dropping’ that assignable item (e.g., releasing the touch input on the display 102aa) on one of the payer icons 106b. Each assignable item may be assigned to one of the payers 106a in such a manner. While a touch input device ahs been described to discuss the assignment of assignable items and costs in the primary bill 108a, one of skill in the art will recognize that a variety of other methods may be used to assign the assignable items and costs to the payers 106a without departing from the scope of the present disclosure (e.g., using non-touchscreen input devices such as a mouse, trackball, keyboard, voice commands, etc.). In an embodiment, any of the assignable items and costs may be further split between two or more payers 106a (e.g., by inputting a percentage of the item to assign to each of a plurality of the payers 106a, by inputting an amount of the assignable costs (e.g., the assignable costs 108ba, 108ca, 108da, and 108ea) to assign to each of a plurality of the payers 106a, etc.). Furthermore, multi-touch inputs may be used to split an assignable item between two or more payers 106a such as, for example, by using a single touch to select an assignable item, and then multiple touches to separate the assignable item into two or more equal amounts and then dragging respective multiple touches and dropping into the appropriate payer icons 106b.

In an alternative embodiment, illustrated in FIG. 2b, the primary bill 108a has been sent to the plurality of payer devices from a payee requesting payment. As discussed above, a touch input allows a payer to select one of the assignable item 110a (e.g., ENTRÉE 4 in the illustrated embodiment) by touching that assignable item 110a, dragging that item across the display (as indicted by arrow 110b,) and assigning that assignable item to themselves by ‘dropping’ that assignable item on the my-bill icon 200. A payer may assign themselves each assignable item they are responsible for in such a manner, and each assignable item on the primary bill 108a may be assigned using the plurality of payer devices that received the primary bill 108a. In an embodiment, as items are assigned on one payer device, the primary bill 108a is updated on the other payer devices that received the primary bill 108a such that the assigned items are no longer displayed on the primary bill 108a on any of the payer devices.

Referring now to FIGS. 1a, 1g, and 1h, a plurality of secondary bills 110b, 110c, 110d, 110e may be generated from the assignment of assignable items and associated assignable costs discussed above. Each of the secondary bills 110b, 110c, 110d, 110e includes the plurality of the assignable items and assignable costs assigned to the payers 106aa, 106ab, 106ac, and 106ad as discussed. Furthermore, the bill splitting system 102g may determine a tax that is based on the sum of the assignable costs for the assignable items for each secondary bill and use that tax to provide totals 110ba, 110ca, 110da, and 110ea for each respective secondary bill 110b, 110c, 110d, and 110e. For example, the payer device(s) may determine an appropriate tax rate from the primary bill 108a (e.g., by dividing the tax 108g by the subtotal 108f), and then apply that tax rate to the sum of the costs associated with each secondary bill. In an embodiment, each secondary bill 110b, 110c, 110d, and 110e also includes a tip input 110bb, 110cb, 110db, and 110eb. In an embodiment, the tip inputs 110bb, 110cb, 110db, and 110eb may include tip amounts that are automatically calculated based on a percentage of each respective total 110ba, 110ca, 110da, and 110ea, or the tip inputs 110bb, 110cb, 110db, and 110eb may be left blank. In an embodiment, the payer device(s) may check the assignable items/costs assigned and/or the totals 110ba, 110ca, 110da, and 110ea determined for the secondary bills 110b, 110c, 110d, and 110e against the assignable items, assignable costs, subtotal 108f, tax 108g, total 108h, and/or other information on the primary bill 108a to ensure that payment of the secondary bills 110b, 110c, 110d, and 110e will provide full payment of the primary bill 108a. In an embodiment, the payer device(s) may be used to indicate that one or more of the secondary bills are to be paid in person (e.g., with cash or an on-site credit card transaction rather than with the assistance of a mobile payment provider.)

Referring now to FIGS. 1a, 1h, and 1i, the method 100 then proceeds to block 112 where at least one secondary bill is sent to at least one second payer device. The payer device(s) (e.g., the payer device 102a) may then be used to send the secondary bills (e.g., the secondary bills 110c, 110d, and 110e) to respective payment devices (e.g., payment devices 102b, 102c, and/or 102d) by, for example, using respective send buttons 110g, 110h, and 110i or a send-all button 110j. The payer device(s) (e.g., the payer device 102a) may also be used to pay a secondary bill (e.g., the secondary bill 110b) by, for example, using the go-to-pay button 110f. The method 100 then proceeds to block 114 where payment is sent for at least one secondary bill. FIG. 1i illustrates the payer device 102a displaying the secondary bill 110d. In an embodiment, the payer device 102a may also display a payee section 114a that allows the selection of a payee (e.g., one of the payers 106a or one of the payees 106c), entry of payee information (e.g., contact information for a payee and/or a variety of other payee information known in the art), or that includes payee information provided in, for example, block 106 of the method 100. The payer device 102a may be used to enter a tip amount in a tip input 114b, or the tip input 114b may be automatically filled and/or edited. The payer 106a may pay the secondary bill 110d by selecting a pay button 114c to direct a mobile payment provider to pay the amount of the secondary bill 110d to the designated payee.

In an alternative embodiment, illustrated in FIG. 2c, the primary bill 108a has been sent to the plurality of payer devices from a payee requesting payment as described above with reference to FIGS. 2a and 2b. As can be seen in FIG. 2c, the payee section 114a is a pre-filled section with the payee information that may have been determined in block 106 of the method 100 (e.g., with one of the payees 106c as the payee), or that may have been included in the payment request sent by the payee requesting payment. The payer devices (e.g., the payer device 102a) may be used to select a confirm-and-pay icon 202 that will direct a mobile payment provider to send payment to the payee 106c designated in the payee section 114a. In an embodiment, the payee section 114a may be editable to change the payee in the payee section 114a.

In yet another alternative embodiment, the bill splitting system 102g, illustrated in FIG. 1b, may be performed primarily by a payee. For example, a payee may generate the primary bill 108a on a payee device (e.g., the payee device 102e or 102f) and may select payers substantially as discussed above with reference to FIG. 1d with the payee device replacing the payer device 102a. The payee may then split the bill by assigning assignable items and assignable costs on the primary bill 108a amongst the selected payers, substantially as described above with reference to FIG. 1g with the payee device replacing the payer device 102a, to produce the secondary bills illustrated in FIG. 1h. The payee may then send the secondary bills to each of the payers, and those payers may provide payment for the secondary bills substantially as described above with reference to FIG. 1i and/or 2c.

In yet another alternative embodiment, the bill splitting system 102g, illustrated in FIG. 1b, may be performed by a payer that wishes the pay the bill using conventional methods (e.g., a physical credit card or cash transaction at the place of business of the payee.) For example, a payer may select payers substantially as discussed above with reference to FIG. 1d with the payer device 102a. The payer may then split the bill by assigning assignable items and assignable costs on the primary bill 108a amongst the selected payers, substantially as described above with reference to FIG. 1g with the payer device 102a, to produce the secondary bills illustrated in FIG. 1h. The payer may then pay the bill using conventional methods and send the secondary bills to each of the secondary payers, and those secondary payers may provide payment for the secondary bills to the payer who paid the bill.

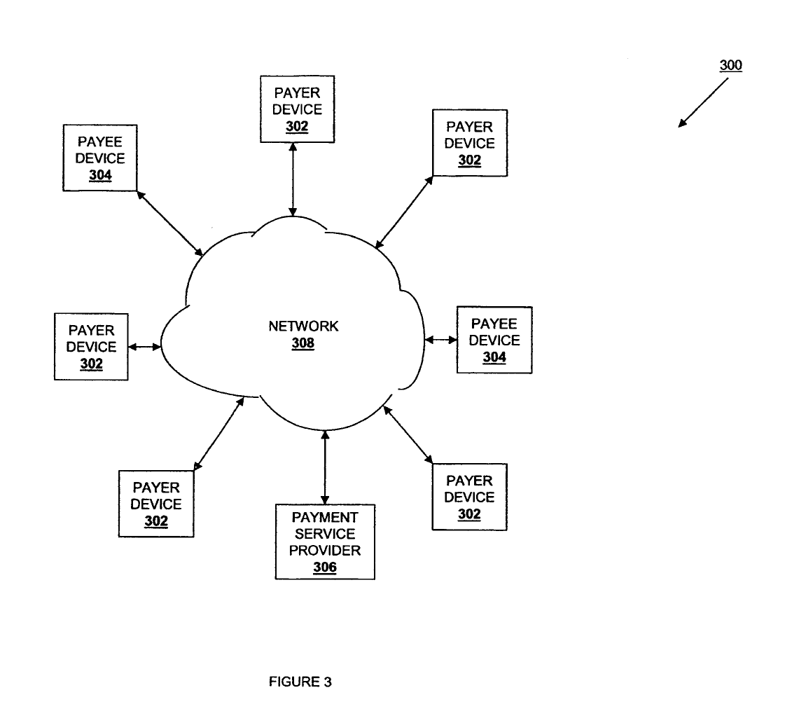

Referring now to FIG. 3, an embodiment of a networked system 300 used in the bill splitting system 102g is illustrated. The networked system 300 includes a plurality of payer devices 302, a plurality of payee devices 304, and a payment service provider 306 in communication over a network 308. The payer devices 302 may be any or all of the payer devices 102a, 102b, 102c, and/or 102d. The payee devices 304 may be any or all of the payee devices 102e and/or 102f. The payment service provider 308 may be a payment service provider such as, for example, PayPal Inc. of San Jose, Calif.

The payer devices 302, a plurality of payee devices 304, and a payment service provider 306 (discussed in further detail below) may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 300, and/or accessible over the network 308.

The network 308 may be implemented as a single network or a combination of multiple networks. For example, in various embodiments, the network 308 may include the Internet and/or one or more intranets, landline networks, wireless networks, and/or other appropriate types of networks.

The payer device 302 may be implemented using any appropriate combination of hardware and/or software configured for wired and/or wireless communication over network 308. For example, in one embodiment, the payer device 302 may be implemented as a personal computer of a payer in communication with the Internet. In other embodiments, the payer device 302 may be a smart phone, personal digital assistant (PDA), laptop computer, and/or other types of computing devices.

The payer device 302 may include one or more browser applications which may be used, for example, to provide a convenient interface to permit the payer to browse information available over the network 308. For example, in one embodiment, the browser application may be implemented as a web browser configured to view information available over the Internet.

The payer device 302 may also include one or more toolbar applications which may be used, for example, to provide payer-side processing for performing desired tasks in response to operations selected by the payer. In one embodiment, the toolbar application may display a user interface in connection with the browser application.

The payer device 302 may further include other applications as may be desired in particular embodiments to provide desired features to the payer device 302. In particular, the other applications may include a payment application for payments through the payment service provider 306. The other applications may also include security applications for implementing user-side security features, programmatic user applications for interfacing with appropriate application programming interfaces (APIs) over the network 308, or other types of applications. Email and/or text applications may also be included, which allow the payer to send and receive emails and/or text messages through the network 308. The payer device 302 includes one or more user and/or device identifiers which may be implemented, for example, as operating system registry entries, cookies associated with the browser application, identifiers associated with hardware of the payer device 302, or other appropriate identifiers, such as a phone number. In one embodiment, the user identifier may be used by the payment service provider 306 to associate the payer with a particular account maintained by the payment service provider 306 as further described herein.

The payee device 304 may be maintained, for example, by an on-line merchant, digital goods seller, individual seller, and/or application developer offering various products and/or services in exchange for payment to be received over the network 308. In this regard, the payee device 304 may include a database identifying available products and/or services (e.g., collectively referred to as items) which may be made available for viewing and purchase by the payer.

The payee device 304 also includes a checkout application which may be configured to facilitate the purchase by the payee of items. The checkout application may be configured to accept payment information from the payee and/or from the payment service provider 306 over the network 308.

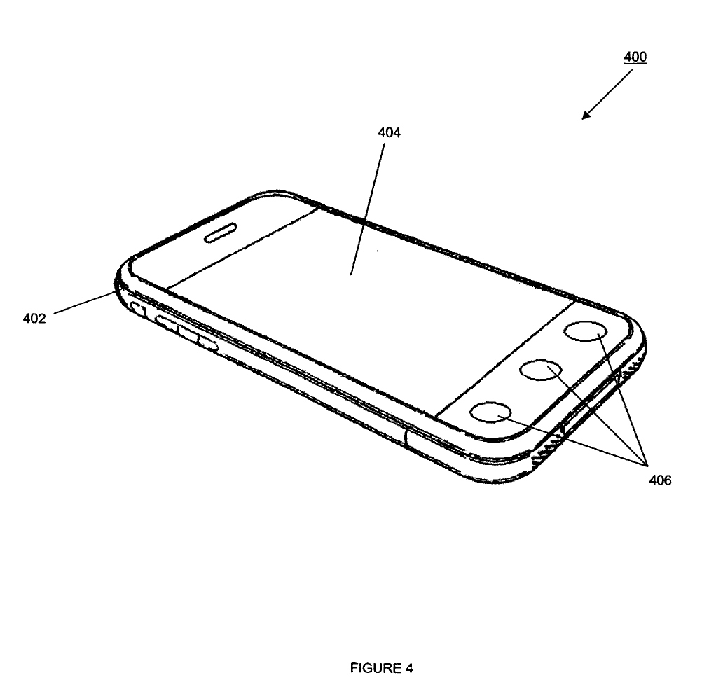

Referring now to FIG. 4, an embodiment of a payer device 400 is illustrated. The payer device 400 may be any or all of the payer devices 102a, 102b, 102c, and/or 102d. The payer device 400 includes a chassis 402 having a display 404 and an input device including the display 404 and a plurality of input buttons 406. One of skill in the art will recognize that the payer device 400 is a portable or mobile phone including a touch screen input device and a plurality of input buttons that allow the functionality discussed above with reference to the method 100. However, a variety of other portable or mobile payer devices may be used in the method 100 without departing from the scope of the present disclosure.

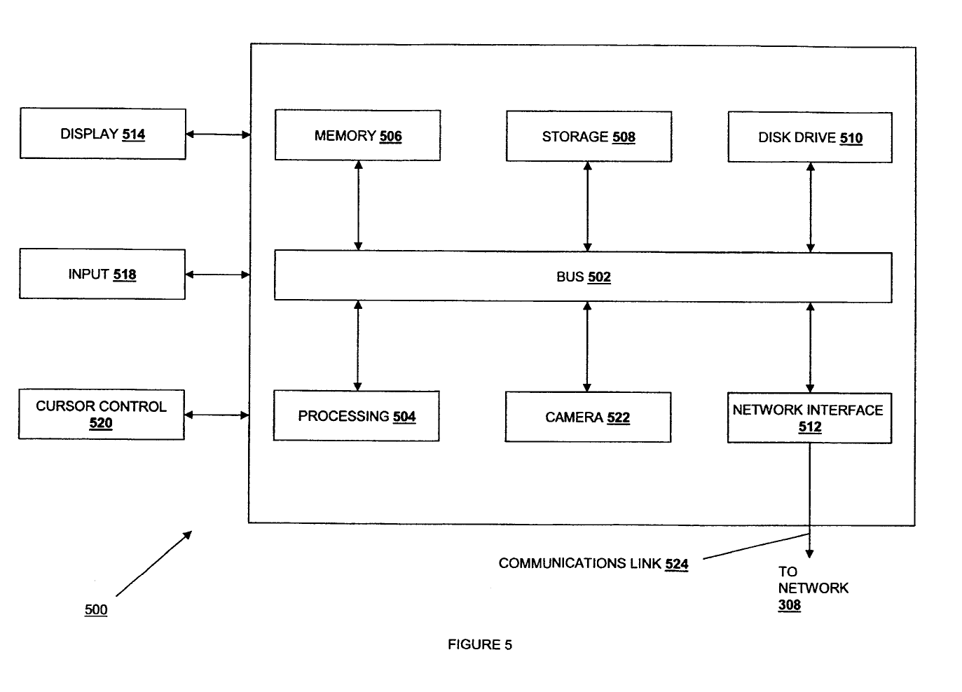

Referring now to FIGS. 3 and 5, an embodiment of a computer system 500 suitable for implementing, for example, the payer devices 102a, 102b, 102c, 102d, 302, and/or 400, is illustrated. In various implementations, the payer device(s) may comprise a computing device (e.g., a computer, laptop, smart phone, PDA, etc.) capable of communicating with the network 308. Furthermore, the payee device(s) 102e, 102f, and/or 304 and/or the payment service provider 306 may implement the computer system 500 as well. It should be appreciated that other devices utilized by payers, payees, and payment providers in the bill splitting system 102g may be implemented as the computer system 200 in a manner as follows.

In accordance with various embodiments of the present disclosure, computer system 500, such as a computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 518 (e.g., keyboard, keypad, or virtual keyboard), a cursor control component 520 (e.g., mouse, pointer, or trackball), and/or a camera 522. In one implementation, the disk drive component 510 may comprise a database having one or more disk drive components.

In accordance with embodiments of the present disclosure, the computer system 500 performs specific operations by the processor 504 executing one or more sequences of instructions contained in system the memory component 506, such as described herein with respect to the payer device 302, the payee device 304, and/or the payment service provider 306. Such instructions may be read into the system memory component 506 from another computer readable medium, such as the static storage component 508 or the disk drive component 510. In other embodiments, hard-wired circuitry may be used in place of or in combination with software instructions to implement the present disclosure.

Logic may be encoded in a computer readable medium, which may refer to any medium that participates in providing instructions to the processor 504 for execution. Such a medium may take many forms, including but not limited to, non-volatile media, volatile media, and transmission media. In various implementations, non-volatile media includes optical or magnetic disks, such as the disk drive component 510, volatile media includes dynamic memory, such as the system memory component 506, and transmission media includes coaxial cables, copper wire, and fiber optics, including wires that comprise the bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 500. In various other embodiments of the present disclosure, a plurality of the computer systems 500 coupled by a communication link 524 to the network 308 (e.g., such as a LAN, WLAN, PTSN, and/or various other wired or wireless networks, including telecommunications, mobile, and cellular phone networks) may perform instruction sequences to practice the present disclosure in coordination with one another.

The computer system 500 may transmit and receive messages, data, information and instructions, including one or more programs (i.e., application code) through the communication link 524 and the network interface component 512. The network interface component 512 may include an antenna, either separate or integrated, to enable transmission and reception via the communication link 524. Received program code may be executed by processor 504 as received and/or stored in disk drive component 510 or some other non-volatile storage component for execution.

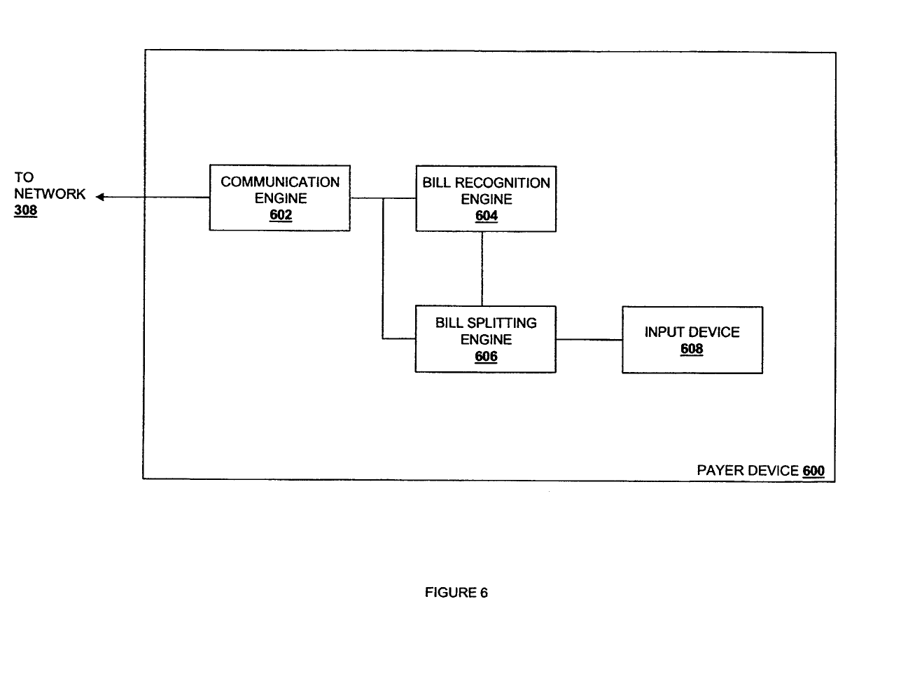

Referring now to FIGS. 3 and 6, an embodiment of a payer device 600 is illustrated. The payer device includes a communication engine 602 that is coupled to the network 308, a bill recognition engine 604, and a bill splitting engine 606. The bill recognition engine 604 is coupled to the bill splitting engine 606 which is coupled to an input device 608. The communication engine 602 may be software or instructions stored on a computer-readable medium that allows the payer device to send and receive information over the network 208. The bill recognition engine 604 may be software or instructions stored on a computer-readable medium that is operable to receive information from the communication engine 602 and perform optical character recognition techniques on a physical bill to produce a primary bill, as discussed above. The bill splitting engine 606 may be software or instructions stored on a computer-readable medium that is operable to receive the primary bill from the communication engine 602 or the bill recognition engine 604, and also receive inputs from the input device 608 in order to assign items on the primary bill to payers, as discussed above. The input device 608 may be any of the input devices discussed above.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and seller; however, a user or consumer can pay virtually, or otherwise interact with any type of recipient, including charities and individuals. The payment does not have to involve a purchase, but can be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for splitting a bill, comprising:
displaying a primary bill on a display of at least one payer device, wherein the primary bill includes a plurality of items;
receiving a plurality of inputs from an input device on the at least one payer device, wherein the plurality of inputs assign the plurality of items to a first payer and at least one second payer to generate a first secondary bill and at least one second secondary bill; and
sending a payment for the first secondary bill from the at least one payer device over a network.

2. The method of claim 1, wherein the displaying the primary bill on the display of the at least one payer device comprises displaying the primary bill on a first payer device, the receiving the plurality of inputs from the input device on the at least one payer device comprises receiving the plurality of inputs from the input device on the first payer device, and the sending the payment for the first secondary bill from the at least one payer device comprises sending the payment for the first secondary bill from the first payer device, and wherein the method further comprises:
sending the at least one second secondary bill to at least one second payer device.

3. The method of claim 1, wherein the displaying the primary bill on the display of the at least one payer device comprises displaying the primary bill on a plurality of payer devices, the receiving the plurality of inputs from the input device on the at least one payer device comprises receiving the plurality of inputs from the input device on the plurality of payer devices, and the sending the payment for the first secondary bill from the at least one payer device comprises sending the payment for the first secondary bill from a first payer device, and wherein the method further comprises: sending a payment for the at least one second secondary bill from at least one second payer device.

4. The method of claim 1, further comprising:
displaying on a display of a first payer device a plurality of payers; and
receiving a selection of the at least one second payer.

5. The method of claim 1, further comprising:
receiving payee information, wherein the sending the payment for the first secondary bill from the at least one payer device comprises sending the payment to a payee using the payee information.

6. The method of claim 1, further comprising:
receiving an image of a physical bill on the at least one payer device; and
performing optical character recognition on the image to produce the primary bill.

7. The method of claim 6, wherein the receiving the plurality of inputs from the input device on the at least one payer device further comprises:
receiving, for each item on the assignable bill, a selection of one of the first payer or the at least one second payer to associate with that item.

8. The method of claim 7, wherein the input device on the at least one payer device comprises a touch input device, and wherein the receiving the selection of one of the first payer or the at least one second payer to associate with each of the items comprises receiving a touch input for each item that selects that item, drags that item across the display, and drops that item into a payee icon.

9. A machine-readable medium comprising a plurality of machine-readable instructions which, when executed by one or more processors, are adapted to cause the one or more processors to perform a method comprising:
displaying a primary bill on a display, wherein the primary bill includes a plurality of items;
receiving a plurality of inputs from an input device, wherein the plurality of inputs assign the plurality of items to a first payer and at least one second payer to generate a first secondary bill and at least one second secondary bill; and
sending a payment for the first secondary bill over a network.

10. The machine-readable medium of claim 9, wherein the displaying the primary bill on the display comprises displaying the primary bill on the display of a first payer device, the receiving the plurality of inputs from the input device comprises receiving the plurality of inputs from the input device on the first payer device, and the sending the payment for the first secondary bill over the network comprises sending the payment for the first secondary bill from the first payer device over the network, and wherein the plurality of machine-readable instructions, when executed by the one or more processors, are adapted to cause the one or more processors to perform the method further comprising:
sending the at least one second secondary bill to at least one second payer device.

11. The machine-readable medium of claim 9, wherein the displaying the primary bill on the display comprises displaying the primary bill on the display of a plurality of payer devices, the receiving the plurality of inputs from the input device comprises receiving the plurality of inputs from the input device on the plurality of payer devices, and the sending the payment for the first secondary bill over the network comprises sending the payment for the first secondary bill from a first payer device over the network, and wherein the plurality of machine-readable instructions, when executed by the one or more processors, are adapted to cause the one or more processors to perform the method further comprising:
sending a payment for the at least one second secondary bill from at least one second payer device over the network.

12. The machine-readable medium of claim 9, wherein the plurality of machine-readable instructions, when executed by the one or more processors, are adapted to cause the one or more processors to perform the method further comprising:
displaying on a display a plurality of payers; and
receiving a selection of the at least one second payer.

13. The machine-readable medium of claim 9, wherein the plurality of machine-readable instructions, when executed by the one or more processors, are adapted to cause the one or more processors to perform the method further comprising:
receiving payee information, wherein the sending the payment for the first secondary bill comprises sending the payment to a payee using the payee information.

14. The machine-readable medium of claim 9, wherein the plurality of machine-readable instructions, when executed by the one or more processors, are adapted to cause the one or more processors to perform the method further comprising:
receiving an image of a physical bill; and
performing optical character recognition on the image to produce the primary bill.

15. The machine-readable medium of claim 14, wherein the receiving the plurality of inputs from the input device further comprises:
receiving, for each item on the assignable bill, a selection of one of the first payer or the at least one second payer to associate with that item.

16. The machine-readable medium of claim 15, wherein the input device comprises a touch input device, and wherein the receiving the selection of one of the first payer or the at least one second payer to associate with each of the items comprises receiving a touch input for each item that selects that item, drags that item across the display, and drops that item into a payee icon.

17. A bill splitting system comprising:
means for displaying a primary bill on at least one payer device, wherein the primary bill includes a plurality of items;
means for receiving a plurality of inputs on the at least one payer device, wherein the plurality of inputs assign the plurality of items to a first payer and at least one second payer to generate a first secondary bill and at least one second secondary bill; and
means for sending a payment for the first secondary bill from the at least one payer device over a network.

18. The system of claim 17, further comprising:
means for receiving an image of a physical bill on the at least one payer device; and
means for performing optical character recognition (OCR) on the image to produce the primary bill.

19. The system of claim 18, further comprising:
means for receiving, for each item on the assignable bill, a selection of one of the first payer or the at least one second payer to associate with that item.

20. The system of claim 17, wherein means for receiving a plurality of inputs on the at least one payer device comprises means for receiving a plurality of touch inputs, and wherein the means for receiving the selection of one of the first payer or the at least one second payer to associate with each of the items comprises means for receiving a touch input for each item that selects that item, drags that item across the display, and drops that item into a payee icon.
